(19) United States
(12) Patent Application Publication
(10) Pub. No.: US 2006/0130823 A1
(43) Pub. Date: Jun. 22, 2006

(54) Gear type machining tip and tool attaching the same thereon

(76) Inventors: Soo Kwang Kim, Seoul (KR); Chang Hyun Lee, Gyeonggi-do (KR); In Seok Choi, Gyeonggi-do (KR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 10/543,260

(22) PCT Filed: Mar. 7, 2003
(86) PCT No.: PCT/KR03/00451

§ 371 Date: Jul. 25, 2005

(30) Foreign Application Priority Data
Mar. 6, 2003 (KR) 10-2003-0014166

(51) Int. Cl. B28D 1/04

(52) U.S. Cl. 125/15

(57) ABSTRACT

The invention relates to a serrated cutting tip and a serrated cutting tool having the cutting attached thereto capable of working a work piece at a fixed workability. The cutting tip includes a bond layer, which has super abrasive particles contained therein and grooves formed on a face which is in contact with the work piece, and a blank layer for strongly supporting the bond layer, by which a working plane of the cutting tip contacting the work piece is uniformly maintained during working use and debris can be readily discharged. As a result, workability is improved and lifetime is prolonged.

### TECHNICAL FIELD

The present invention relates to a cutting tool for cutting, grinding or drilling a work piece such as concrete and stone, and more particularly, to a serrated cutting tip of a double-layer structure capable of working a work piece at a predetermined working rate and a serrated cutting tool having the cutting tip attached thereon.

### BACKGROUND ART

First, brief definition will be made for terms in the specification, which will be consistently used through out the specification.

Super abrasive or super abrasive particles mean super hard particles typically of Diamond or Cubic Boron Nitride (CBN) with relatively higher hardness.

A cutting tip means a body for grinding or cutting a work piece, which is manufactured by fabrication processes including the step of mixing the super abrasive particles with bond, and classified into a segmental tip and a continuous rim tip.

The segment-type cutting tip is an arc-shaped piece of a predetermined length, a predetermined width and a predetermined height, and attached to the outer periphery of a shank.

The rim-type cutting tip is a rounded rim-shaped body having a predetermined width and height attached to the outer periphery of the shank.

A turbo-type means a grooved configuration in both lateral surfaces perpendicular to a working plane of the segment- or rim-type cutting tip.

The turbo-segment-type cutting tip means the segment-type cutting tip including the grooves formed on both lateral surfaces of the cutting tip.

The turbo-continuous rim cutting tip means the continuous rim cutting tip including the grooves formed on the both lateral faces of the cutting tip.

Bond or adhesive is composed of metal powder for holding the super abrasive particles in the cutting tip and assisting the super abrasive particles to continuously self-sharpen.

A blank layer means a layer which is placed between the shank via a heat source such as silver soldering and laser between the shank and the cutting tip without super abrasive particles to attach the cutting tip to the shank.

A bond layer is a concept in relative to the blank layer when the blank layer is attached to the cutting tip, and means a portion in which the super abrasive particles are sintered via bond.

A working plane means a face or plane of the cutting tip in contact with the work piece.

A super abrasive tail means a non-ground linear projection in the cutting tip which is extended from the rear of a super abrasive particle in a direction reverse to the rotation direction of the cutting tip as it rotates along with the shank.

A shank or working wheel means a body shaped as a disk or cylinder made of a steel material, and is classified in a cutting wheel, a grinding wheel, and a drilling wheel.

A cutting tool means a tool having the cutting tip attached to its outer periphery for cutting, grinding or drilling a work piece, and is divided into a cutting tool, a grinding tool and a drilling tool according to the use.

A working machine means a comprehensive apparatus which includes the cutting tool for directly contacting the work piece to work the same, a motor for powering the cutting tool, electrical and/or mechanical devices connected with the motor and so on.

In general, a tool for cutting or drilling a work piece includes a shank of a predetermined diameter and a cutting tip attached to the outer periphery of the shank. The cutting tip of a high strength and/or hardness is fabricated to contain super hard abrasive particles such as Diamond or CBN. The cutting tip is classified into a segmental and a continuous rim according to the configuration attached to the outer periphery of the shank. Each cutting tip can be fabricated as a turbo-type cutting tip by further forming grooves in faces perpendicular to the plane in contact with the work piece.

FIG. 1 is a perspective view of a segmental cutting tip 1 of the prior art.

As shown in FIG. 1, the cutting tip 1 is shaped as a hexahedron of a predetermined size containing super abrasive particles 2 therein. The cutting tip 1 is curved at a radius of curvature same as that of the outer periphery of a shank 3 so that the cutting tip 1 can be tightly coupled in its longitudinal direction with the outer periphery of the shank 3.

FIG. 2 is a perspective view of a conventional turbo-segmental cutting tip 1-1.

As shown in FIG. 2, the cutting tip 1-1 contains super abrasive particles 2-1 therein and has grooves on both lateral faces 4-1 perpendicular to a working plane which will contact with a work piece to be worked. The cutting tip 1-1 is curved at a radius of curvature same as that of the outer periphery of a shank 3-1 so that the cutting tip 1-1 can be tightly coupled in its longitudinal direction with the outer periphery of the shank 3-1.

The cutting tools of the above constructions are fabricated as follows: Super abrasive particles such as Diamond or CBN are mixed with binder such as metal powder to prepare a mixture, which is poured into a mold. The mixture is compressed, formed and sintered in the mold to fabricate a cutting tip in the form of a segment or rim. The cutting tip is attached via silver soldering, welding or sintering to the outer periphery of a shank of a predetermined diameter to complete a cutting tool for working a work piece.

The cutting tool which mainly performs a cutting use is also referred to as a saw blade.

The use of the cutting tool fabricated as above will be described as follows in reference to a cutting tool for use in cutting a work piece.

The cutting tool is axially coupled with an actuator, and when the actuator operates rotating its shaft, transfers the rotating force of the shaft to a work piece such as stone or concrete. Then, the work piece is cut from the impact and friction generated from the super abrasive particles resulting from rotation of the cutting tip of the cutting tool.

Although some of super abrasive particles contained in the cutting tip are also broken, separated or abraded during the cutting use of the work piece by the cutting tip, other super abrasive particles are newly projected from a working plane of the cutting tip in contact with the work piece so as to work (e.g., cut, drill and grind) the work piece at a uniform rate. Such a use of the super abrasive particles for working the work piece is referred to as self-sharpening.

In order that such self-sharpening can be efficiently carried out on the working plane, the total abrasive particles in a bond layer projected out of the working plane are required to have a uniform rate among the number of whole crystals which are newly projected from the bond layer, micro-crushed crystals which are partially broken but able to work the work piece and macro-crushed and popped-out crystals which are completely broken and incapable of working the work piece.

However, in case of working a high-strength work piece, the sharp facets of super abrasive particles which project from the cutting tip are readily dulled. Then, the exposed position of the particles is not maintained at a uniform rate. That is, as dull particles remain in the bond layer at a relatively higher rate without readily dropping from the working plane, the dull particles are under a relatively higher friction load from the work piece. Then, the working rate of the cutting tip slows down and its impulsive force is further reduced so as to gradually increase the frequency of the dull super abrasive particles in contact with the work piece. As a result, continuous working is disabled.

Recently, the use of high-strength concrete containing gravel and/or steel reinforcement has increased significantly. In the case of cutting such high-strength work piece, the super abrasive particles are dulled at a relatively more rapid rate so that the working rate is progressively slowed down proportional to progress of the work.

As a result the super abrasive particles in the cutting tip are dulled, losing cutting ability and self-sharpening ability resulting in increased frictional load. Owing to deformation of the cutting wheel and/ or high temperature generated during cutting, the super abrasive particles and/or bond in the cutting tip readily deteriorate and may separate during the cutting use potentially causing severe safety problems.

The following description will present conventional technologies for solving the above problems.

FIGS. 3A and 3B are perspective views of another conventional segmental tip structures disclosed in Japanese Patent Application No. 1998-58329, published on Mar. 3, 1998.

The conventional cutting tip 1-2 shown in FIG. 3A contains super abrasive particles 2-2 therein, and is curved at a radius of curvature same as that of the outer periphery of a shank 3-2 so that the cutting tip 1-2 can be tightly coupled in its longitudinal direction with the outer periphery of the shank 3-2. The cutting tip 1-2 also has V- or U-shaped grooves 5-1 formed to a predetermined width and a predetermined depth in a plane which is in contact with a work piece to be worked.

The conventional cutting tip 1-3 shown in FIG. 3B contains super abrasive particles 2-3 therein, and is curved at a radius of curvature same as that of the outer periphery of a shank 3-3 so that the cutting tip 1-3 can be tightly coupled in its longitudinal direction with the outer periphery of the shank 3-3. The cutting tip 1-3 also has U-shaped grooves 5-2 formed to a predetermined width and a predetermined depth in a plane which is contact with a work piece to be worked.

The cutting tips 1-2 and 1-3 disclosed in Japanese Patent Application No. 1998-58329 respectively have the grooves 5-1 and 5-2 formed on the working plane which is in contact with the work piece in order to prevent shaking of the shank resulting from eccentricity of the cutting tool at the initial working stage and defective dressing of the super abrasive particles. Thus, the cutting tips 1-2 and 1-3 have an excellent cutting ability in the initial working stage. However, after use the bottoms of the grooves contact with the surface of the work piece, the working plane of the cutting tips 1-2 and 1-3 become flat increasing the area which is in contact with the work piece and thus the cutting tips 1-2 and 1-3 are suddenly under a high working load. Therefore, the cutting tip has a problem in that its cutting ability is not uniform along the entire height of the cutting tip from the outer periphery of the wheel.

Where the grooves of the cutting tip are formed deeper from the working plane, the brittleness of the bond layer is raised owing to the super abrasive particles contained in the bond layer. Then, the cutting tip may be readily broken from the shank under a small amount of lateral load owing to vibration or impact, potentially endangering the safety of a worker. Therefore, the cutting tip 1-2 and 1-3 are necessarily fabricated so that the depth of the grooves is less than the half of the entire height of the cutting tip.

Further, since the grooves are formed for the purpose of preventing eccentricity and/or shaking that may occur at the initial working stage of the cutting tool, the depth of the grooves is restricted within about 1 to 2 mm. As a result, the cutting tip 1-2, 1-3 shows improvement in the cutting ability only in the initial working stage.

FIG. 3C is a perspective view of a further another conventional segmental cutting tip 1-4 which is disclosed in U.S. Pat. No. 5,392,759, registered on Feb. 28, 1995 and U.S. Pat. No. 5,316,416, registered on May 31, 1994.

The cutting tip 1-4 shown in FIG. 3C contains super abrasive particles 2-4 therein, and is curved at a radius of curvature same as that of the outer periphery of a shank 3-4 so that the cutting tip 14 can be tightly coupled in its longitudinal direction with the outer periphery of the shank 3-4. The cutting tip 1-4 also has first grooves 5-3 angled to a first predetermined width and a first predetermined depth in an upper plane which is in contact with a work piece to be worked and second grooves 5-4 angled to a second predetermined width and a second predetermined depth in a lower plane which is in contact with the outer periphery of the shank.

The first angled grooves 5-3 and the second angled grooves 5-4 are formed deeper than the half of the entire height of the cutting tip to have overlapped portions m (no “m” on the drawing) in a central portion of the cutting tip along the height.

The above cutting tip 1-4 solved some of the problems of the cutting tips 1-2 and 1-3 disclosed in Japanese Patent Application No. 1998-58329 (published on Mar. 3, 1998). However, when the first angled grooves 5-3 in the first plane which is in contact with the work piece are abraded to a predetermined depth h, the area of the cutting tip which is in contact with the work piece is reduced and the cutting tip is divided into several sections owing to the second grooves 5-4 reducing the area of the tip sections contacting the shank. Then, the tip sections can be readily separated from the shank under relatively low lateral load owing to vibration or impact, thereby endangering a worker. In particular, a hand-held cutting tool may cause a more severe danger to the worker.

FIG. 3D is a perspective view of a yet another conventional segmental cutting tip 1-5 disclosed in U.S. Pat. No. 5,433,187, registered on Jul. 18, 1995.

The cutting tip 1-5 shown in FIG. 3D contains super abrasive particles 2-5 therein, and is curved at a radius of curvature same as that of the outer periphery of a shank 3-5 so that the cutting tip 1-5 can be tightly coupled in its longitudinal direction with the outer periphery of the shank 3-5. The cutting tip 1-5 also has first grooves 5-5 angled to a first predetermined width and a first predetermined depth in an upper plane which is in contact with a work piece to be worked and second grooves 5-6 angled to a second predetermined width and a second predetermined depth in a lower plane which is in contact with the outer periphery of the shank.

Herein, the depth of the first angled grooves 5-5 and the second angled grooves 5-6 is formed less than the half of the height of the cutting tip 1-5.

However, because the first and second grooves 5-5 and 5-6 do not overlap with each other at a half position A in a height direction of the cutting tip 1-5, when the working plane is formed at the half position A, the working area of the cutting tip is instantaneously and radically increased to reduce working rate as well as to increase working load.

Therefore, in case of manual use, the operator can hardly control the working rate and thus working load is inadequately applied to the cutting tip so that the cutting tip can be separated from the shank. The bonding area between the cutting tip and the shank is reduced as much as the grooves in the lower end of the cutting tip in the outer periphery of the shank. This proportionally reduces the bonding strength thereby increasing the risk of separation of the cutting tip during use. In case of applying the cutting tool to a machine which performs a continuous use under fixed working conditions such as a feeding rate, a cutting depth and a rotation rate, cutting load may abruptly increase applying excessive working load to both the tool and the machine. As a result, the shank may be bent, the cutting tool fail to work the work piece into a desired shape, or the cutting tool may fail.

### DISCLOSURE OF INVENTION

Therefore, the present invention has been made in view of the foregoing problems, and it is an object of the present invention to provide a serrated cutting tip and a serrated cutting tool having the serrated cutting tip attached thereto, by which the area of the working plane can be maintained substantially uniform while a work piece is worked as well as providing for ready discharge of debris thus prolonging the life of the tool.

It is another object of the invention to provide a serrated cutting tip and a serrated cutting tool having the serrated cutting tip attached thereto in which grooves for applying a suitable amount of impact to the work piece are formed on a working plane so that the serrated cutting tip can work the work piece in a rapid and continuous manner.

It is further another object of the invention to provide a serrated cutting tip and a serrated cutting tool having the serrated cutting tip attached thereto, by which debris from a work piece can be readily discharged so that debris may not interfere between a working plane and the work piece, thereby preventing secondary abrasion of the cutting tip and providing an accelerated working rate.

According to an aspect of the invention for accomplishing the above objects, there is provided a cutting tip attached to an outer periphery of a shank, which has a predetermined rotation radius and a first thickness, and functioning to work a work piece, the cutting tip comprising: a bond layer having a first width in a direction of the first thickness, a first height in a direction same as that of the shank and a radius of curvature same as that of the shank, wherein the bond layer includes grooves which are alternatingly formed on a first plane of the bond layer contacting the work piece and a second plane of the bond layer adjacent to the outer periphery of the shank; and a blank layer having a second width in a direction of the first thickness, a second height in a direction same as that of the shank and a radius of curvature same as that of the shank, the blank layer being tightly coupled with the bonding layer in a corresponding manner with the grooves formed on the second plane of the bond layer adjacent to the outer periphery of the shank to attach the bond layer to the outer periphery of the shank, wherein the bond layer contains super abrasive particles and metal powder, and the blank layer contains metal powder.

According to another aspect of the invention for accomplishing the above objects, there is provided a serrated cutting tool comprising: a shank having a predetermined rotation radius and a first thickness; and a cutting tip attached to an outer periphery of the shank for working a work piece, wherein the cutting tip comprises: a bond layer having a first width in a direction of the first thickness, a first height in a direction same as that of the shank and a radius of curvature same as that of the shank, wherein the bond layer includes grooves which are alternatingly formed on a first plane of the bond layer which is in contact the work piece and a second plane of the bond layer adjacent to the outer periphery of the shank; and a blank layer having a second width in a direction of the first thickness, a second height in a direction same as that of the shank and a radius of curvature same as that of the shank, the blank layer being tightly coupled with the bonding layer in a corresponding manner with the grooves formed on the second plane of the bond layer adjacent to the outer periphery of the shank to attach the bond layer to the outer periphery of the shank, and wherein the bond layer contains super abrasive particles and metal powder, and the blank layer contains metal powder.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view of a segmental cutting tip of the prior art;

FIG. 2 is a perspective view of a conventional turbo-segmental cutting tip;

FIGS. 3A to 3D are perspective views of conventional segmental cutting tips;

FIG. 4 is a perspective view of a segmental cutting tip according to a first embodiment of the invention;

FIG. 5 is a perspective view of a segmental cutting tip according to a second embodiment of the invention;

FIG. 6 is a perspective view of a segmental cutting tip according to a third embodiment of the invention;

FIG. 7 is a perspective view of a segmental cutting tip according to a fourth embodiment of the invention;

FIG. 8 is a sectional view along a line X-X in FIG. 7;

FIG. 9 is a plan view of a segmental cutting tool of the invention;

FIG. 10 is a plan view of a continuous rim cutting tool of the invention;

FIG. 11 is a perspective view of a segmental drilling tool of the invention;

FIG. 12 is a perspective view of a continuous rim drilling tool of the invention;

FIG. 13 illustrates the use of a segmental cutting tool of the invention;

FIGS. 14A to 14C illustrate variation of a working plane dependent on working time;

FIG. 15A is a graph illustrating the lifetime index of a cutting tip of the invention; and

FIG. 15B is a graph illustrating the workability of a cutting tip of the invention.

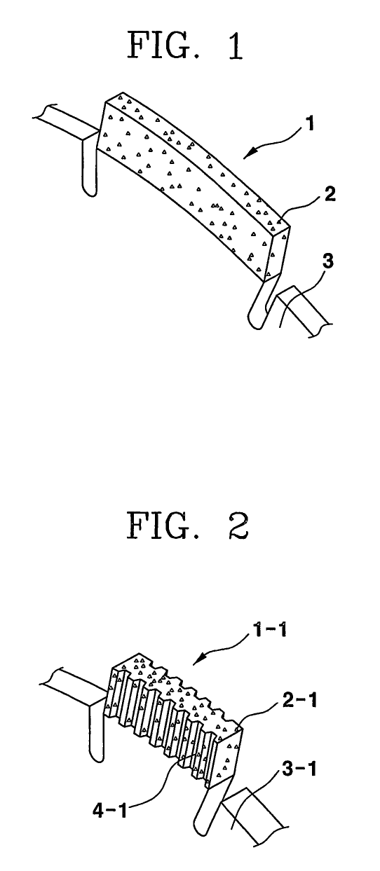

### BEST MODE FOR CARRYING OUT THE INVENTION

Reference will now be made in detail to preferred embodiments of the present invention, examples of which are illustrated in the accompanying drawings.

A serrated cutting tip of the invention of a double-layer structure includes a bond layer, which contains super abrasive particles therein and has grooves formed on a working plane which is in contact with a work piece, and a blank layer for attaching the bond layer to the shank. The serrated cutting tip of the invention is divided into a segmental cutting tip and a continuous rim cutting tip. Further, the cutting tip of the invention is attached to the outer periphery of a cutting tool of the invention, which is divided into a cutting tool, a grinding tool and a drilling tool according to the function. The preferred embodiments of the invention will be described in reference to the segmental cutting tip, but for illustrative purposes only.

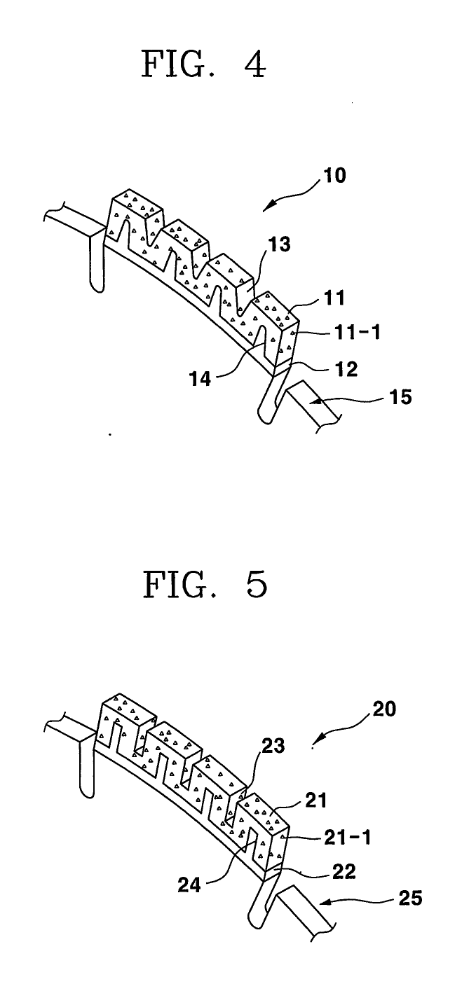

FIG. 4 is a perspective view of a segmental cutting tip 10 according to a first embodiment of the invention.

As shown in FIG. 4, the cutting tip 10 according to the first embodiment of the invention comprises a bond layer 11 and a blank layer 12. The bond layer 11 contains super abrasive particles 11-1 therein, and is curved in length at a radius of curvature same as that of the outer periphery of a shank 15. The blank layer 12 also has V- or U-shaped first grooves 13 formed to a predetermined width and a predetermined depth in a working plane of the bond layer 11 and V- or U-shaped second grooves 14 formed to a second predetermined width and a second predetermined depth in a lower plane of the bond layer 11 adjacent to the outer periphery of the shank 15. The second grooves 14 alternate with the first grooves 13. The blank layer 12 is formed to a predetermined thickness (or height) in a same radial direction of the shank 15, and tightly coupled with the second grooves 14 to attach the bond layer 11 to the outer periphery of the shank 15. Since the second grooves 14 are attached to the outer periphery of the shank, the second grooves 14 will be also referred to as outer peripheral grooves.

Herein, the depth of the first and second grooves 13 and 14 is larger than the half of the entire height of the bond layer 11, and thus the first and second grooves 13 and 14 respectively reach beyond a position in the half of the entire height of the bond layer 11. Further, the first grooves 13 and the second grooves 14 are opposed to each other in an alternating manner.

The coupling area between the blank layer 12 and the bond layer 11 is enlarged since the blank layer 12 is tightly coupled with the bond layer 11 along the configuration of the outer peripheral grooves 14. This enables the bond layer 11 to be strongly coupled with the shank 15, thereby preventing separation of the cutting tip from the shank during use as well as buffering working impact.

FIG. 5 is a perspective view of a segmental cutting tip 20 according to a second embodiment of the invention.

As shown in FIG. 5, the cutting tip 20 according to the second embodiment of the invention comprises a bond layer 21 and a blank layer 22. The bond layer 21 contains super abrasive particles 21-1 therein, and is curved in length at a radius of curvature same as that of the outer periphery of a shank 25. The blank layer 22 also has first angled grooves 23 formed on a normal direction to a predetermined width and a predetermined depth in a working plane of the bond layer 21 and second angled grooves 24 formed on a normal direction to a second predetermined width and a second predetermined depth in a lower plane of the bond layer 21 adjacent to the outer periphery of the shank 25. The second grooves 24 alternate with the first grooves 23. The blank layer 22 is formed to a predetermined thickness (or height) in a same radial direction of the shank 25, and tightly coupled with the second grooves 24 to attach the bond layer 21 to the outer periphery of the shank 25. Since the second grooves 24 are attached to the outer periphery of the shank, the second grooves 24 will be also referred to as outer peripheral grooves.

Herein, the depth of the first and second grooves 23 and 24 is larger than the half of the entire height of the bond layer 21, and thus the first and second grooves 23 and 24 respectively reach beyond a position in the half of the entire height of the bond layer 21.

The blank layer 22 is tightly coupled with the bond layer 21 along the configuration of the outer peripheral grooves 24. This enables the bond layer 21 to be strongly coupled with the shank 25, thereby preventing separation of the cutting tip from the shank during use as well as buffering working impact.

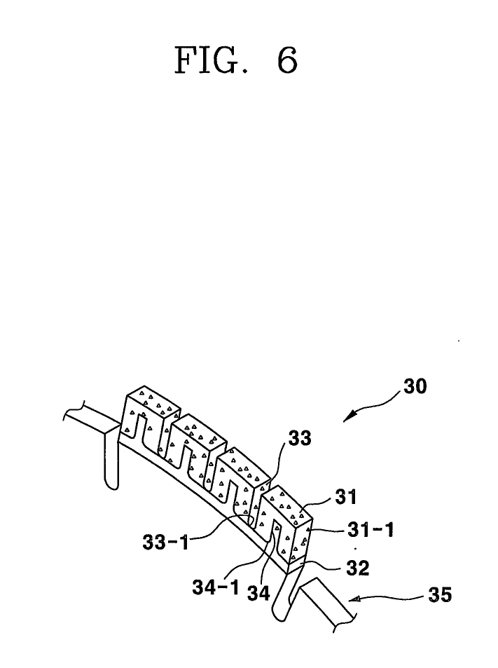

FIG. 6 is a perspective view of a segmental cutting tip 30 according to a third embodiment of the invention.

As shown in FIG. 6, the cutting tip 30 according to the third embodiment of the invention comprises a bond layer 31 and a blank layer 32. The bond layer 31 contains super abrasive particles 31-1 therein, and is curved in length at a radius of curvature same as that of the outer periphery of a shank 35. The blank layer 32 also has first angled grooves 33, which are formed on a normal direction to a predetermined width and a predetermined depth in a working plane of the bond layer 31 and with rounded surfaces at their bottoms 33-1, and second grooves 24, which are formed in a normal direction of the bond layer 31 adjacent to the outer periphery of the shank 35 to a second predetermined width and a second predetermined depth and with rounded surfaces at their entrances 34-1. The second grooves 34 alternate with the first grooves 33. The blank layer 32 is formed to a predetermined thickness (or height) in a same radial direction of the shank 35, and tightly coupled with the second grooves 34 to attach the bond layer 31 to the outer periphery of the shank 35. Since the second grooves 34 are attached to the outer periphery of the shank 35, the second grooves 34 will be also referred to as outer peripheral grooves.

The blank layer 32 is tightly coupled with the bond layer 31 along the configuration of the outer peripheral grooves 34. This enables the bond layer 31 to be strongly coupled with the shank 35, thereby preventing separation of the cutting tip from the shank during use as well as buffering working impact.

Herein, although the bottoms 33-1 of the first grooves are rounded, the bottoms can be realized in various configurations such as an angled configuration for revealing the blank layer. The curved entrances 34-1 can be alternatively angled.

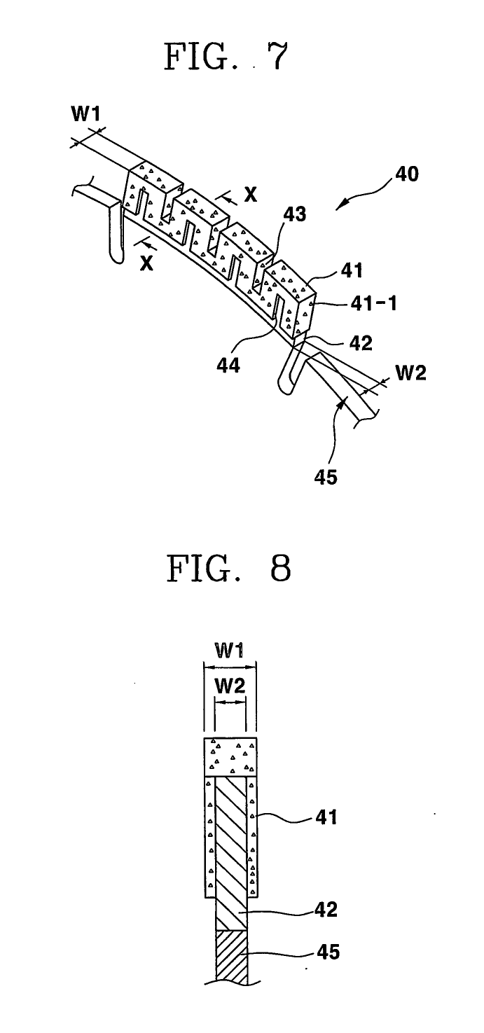

FIG. 7 is a perspective view of a segmental cutting tip 40 according to a fourth embodiment of the invention.

As shown in FIG. 7, the cutting tip 40 according to the third embodiment of the invention comprises a bond layer 41 and a blank layer 42. The bond layer 41 contains super abrasive particles 41-1 therein, and is curved in length at a radius of curvature same as that of the outer periphery of a shank 45. The blank layer 42 also has first angled grooves 44 (no number 44 on drawings) formed on a working plane of the bond layer 41 in a normal direction thereof to a predetermined width and a predetermined depth and second grooves 43 formed adjacent to the outer periphery of the shank 45 in a normal direction of the blank layer 42 to a second predetermined width and a second predetermined depth. The second grooves 44 alternate with the first grooves 43. The blank layer 42 is formed to a predetermined thickness (or height) in a same radial direction of the shank 45, and tightly coupled with the second grooves 44 to attach the bond layer 41 to the outer periphery of the shank 45. Since the second grooves 44 are attached to the outer periphery of the shank 45, the second grooves 44 will be also referred to as outer peripheral grooves.

Herein, the bond layer 41 has a width W1 larger than that W2 of the blank layer 42. FIG. 8 is a sectional view along a line X-X in FIG. 7(there is no X-X in FIG. 7), which illustrates the blank layer 42 of the width W2 coupled with the angled outer peripheral grooves 44 of the width W1, the lateral center of the blank layer 42 being aligned with that of the outer peripheral grooves 44.

The blank layer 42 is tightly coupled with the bond layer 41 along the configuration of the angled outer peripheral grooves 44. This enables the bond layer 41 to be strongly coupled with the shank 45, thereby preventing separation of the cutting tip from the shank during use as well as buffering working impact.

The blank layer 42 of the cutting tip 40 according to the forth embodiment is made of metal powder without containing super abrasive particles. Alternatively, metal powder in the blank layer 42 can be mixed with super abrasive particles to a ratio same as or less than that of the super abrasive particles 41-1 in the bond layer 41 with respect to metal powder in the bond layer 41. That is, the blank layer 42 can be realized by containing the super abrasive particles mixed with metal powder to a ratio same as or less than that of the super abrasive particles 41-1 in the bond layer 41.

The following description will present cutting tools according to preferred embodiments of the invention having the cutting tips of the above configurations attached to the shanks in conjunction with drawings.

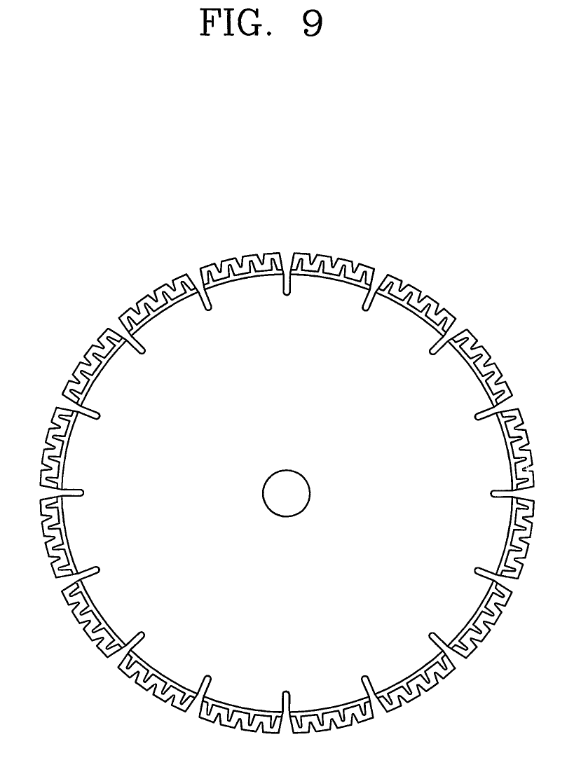

FIG. 9 is a plan view of a segmental cutting tool of the invention, in which segmental cutting tips are attached to the outer periphery of a shank. Herein, each of the segmental cutting tips has a double-layer structure including a bond layer having grooves and a blank layer coupled with the bond layer.

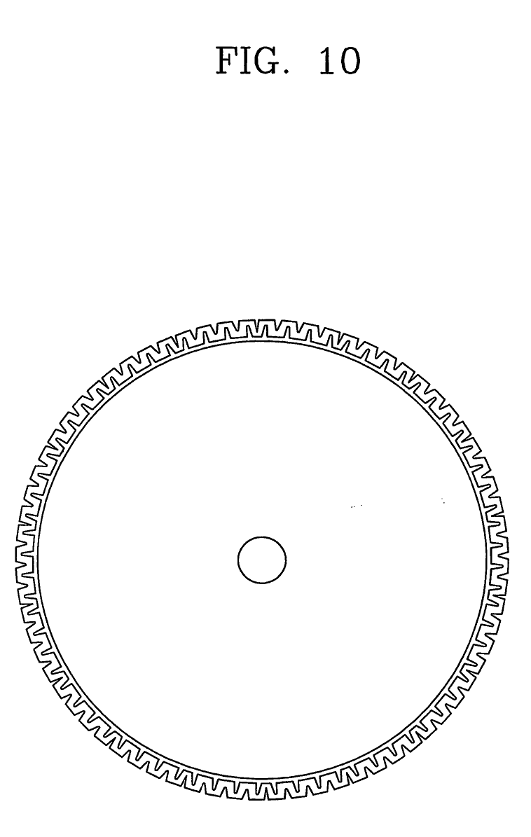

FIG. 10 is a plan view of a continuous rim cutting tool of the invention, in which continuous rim cutting tip is attached to the outer periphery of a shank. Herein, the continuous rim cutting tip is attached to the outer periphery of a shank. Herein, the continuous rim cutting tip has a double-layer structure including a bond layer having grooves and a blank layer coupled with the bond layer.

FIG. 11 is a perspective view of a segmental drilling tool of the invention, in which segmental cutting tips are attached to the outer periphery of a cylindrical shank. Herein, both lateral faces of the whole segmental cutting tips with respect to working plane have common radii of curvature same as those of the cylindrical shank.

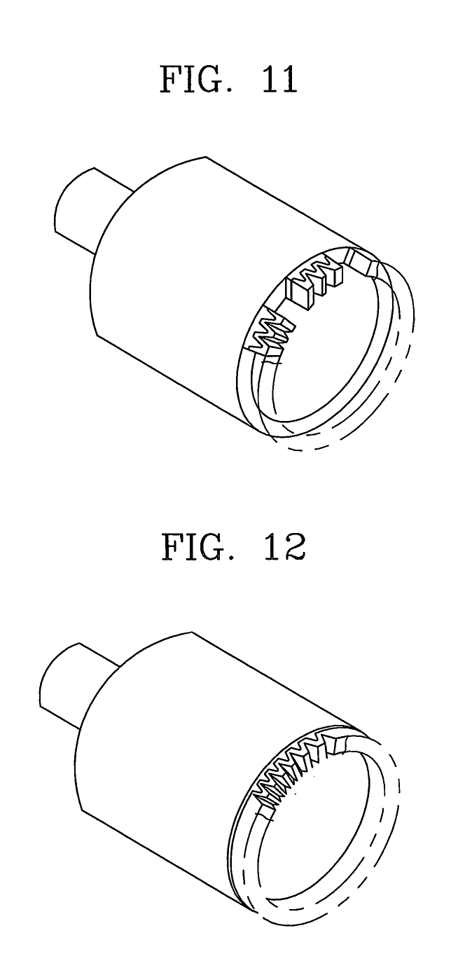

FIG. 12 is a perspective view of a continuous rim drilling tool of the invention, in which a continuous rim cutting tip is attached to the outer periphery of a cylindrical shank. Herein, both lateral faces of the continuous rim cutting tip with respect to a working plane has radii of curvatures same as those of the cylindrical shank.

The cutting tip is bonded to the shank via silver soldering, laser, diffusion sintering and so on.

The following description will present the use of a serrated cutting tip of the invention for working a work piece in reference to the use of a cutting tool having the serrated cutting tip attached thereto.

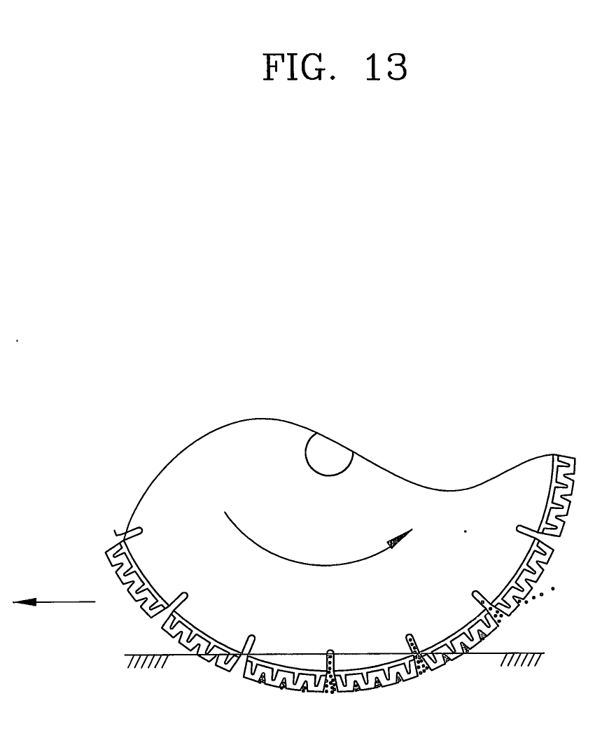

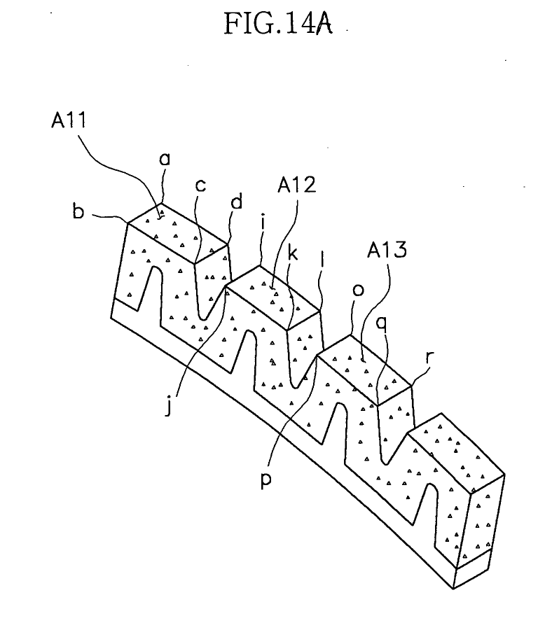

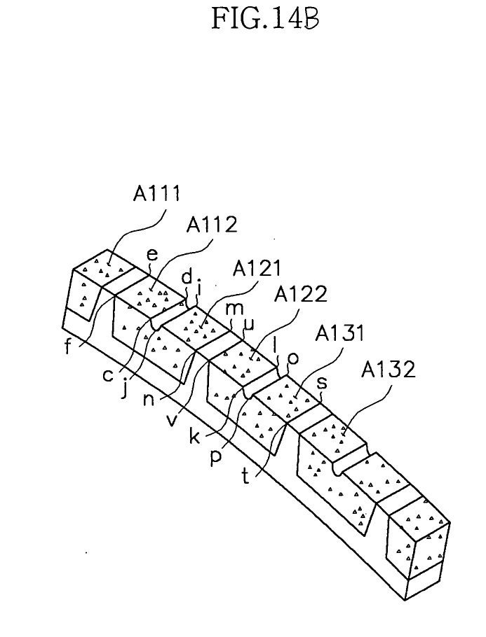

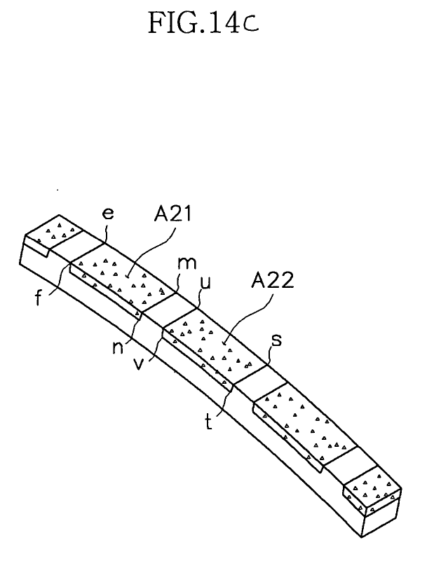

FIG. 13 illustrates the use of the segmental cutting tool of the invention shown in FIG. 9, and FIGS. 14A to 14C illustrate variation of a working plane dependent on working time. A curved arrow in the shank designates the rotation direction of the shank, and a straight arrow out of the wheel designates the advancing direction of the wheel. Further, in case that the wheel is rotated at a fixed position but a work piece is moved during use, a straight arrow (not shown) will be marked inside the work piece. (Note no arrows in drawings, not sure what thios is referring to.)

As shown in FIG. 14A, in rotation of the cutting tool having sub-areas S11(abcd), S12(ijkl) and S3(opqr) in initial working sub-planes A11(abcd), A12(ijkl) and A13(opqr), a bond layer of the cutting tip containing super abrasive particles begins to cut a work piece. Then, the cutting tips readily discharge cutting debris which are generated from the work piece during the cutting use. Herein, the sub-areas S11(abcd), S12(ijkl) and S3(opqr) are equal to one another.

Upon use of the cutting tool for a predetermined time period, the working plane of the cutting tip are abraded as shown in FIG. 14B. Then, grooves in the working plane and outer peripheral grooves divide the working sub-plane A11(abcd) into working sub-planes A111 and A112(efcd), the working sub-plane A12(ijkl) into working sub-planes A121(ijnm) and A22(uvkl) and the working sub-plane A13(opqr) into working sub-planes A131(opts) and A132.

Although upper portions of the blank layer exposed from the working plane do not contain super abrasive particles, the maximum width of thereof is restricted to about 2 to 3 mm corresponding to the length of the tails of the super abrasive particles in the bond layer so that frictional load is not created and the initial cutting ability is maintained. Herein, the tail means a projection in the form of a tail extended from the rear of each abrasive particle in a direction reverse to the rotation direction of the cutting tool. The projection is created since a portion of the bond layer is not rubbing against the work piece and remains without abrasion in the rear of the super abrasive particle opposite to the rotation direction of the super abrasive particle.

Because maximum width of the blank layer portions exposed from the working plane is only about 2 to 3 mm while the bond tail is in the length of about 5 mm, the blank layer portions hardly create any frictional load. Therefore, the blank layer portions rarely influence the initial variation of cutting ability.

Those sub-areas corresponding to the working sub-planes A112(efcd), A121(ijnm), A122(uvkl) and A131(opts) become S112(efcd), S12a(ijmn), S122(uvkl) and S131(opts). Although the number of the working sub-planes is doubled from that of the initial working sub-planes, the area of the initial working plane is substantially equal to the total area of the working sub-planes which are formed after a predetermined working time. For example, S12(ijkl) is equal to S121(ijnm) and S122(uvkl). Therefore, the cutting tip can carry out the cutting use while maintaining the initial cutting ability.

Upon further cutting use of the cutting tool, working sub-planes of the cutting tip come to have a configuration shown in FIG. 14C adjacent to the outer periphery of the shank. A working sub-plane A21(efnm) has an area S21(efnm) equal to that S22 (uvts) of a working sub-plane A22(uvts). Total area of the working sub-planes are equal to those of the initial working sub-planes.

Therefore, according to the cutting tip of the invention, the substantially uniform area maintains the working plane which contacts the work piece during the use of working the work piece and thus their cutting ability and wearing rate are also uniformly maintained. As a result, the cutting tip can have a relatively longer lifetime.

The following description will present results of qualitative analysis on the lifetime and cutting ability of a serrated cutting tip of the invention, for example, in working a work piece.

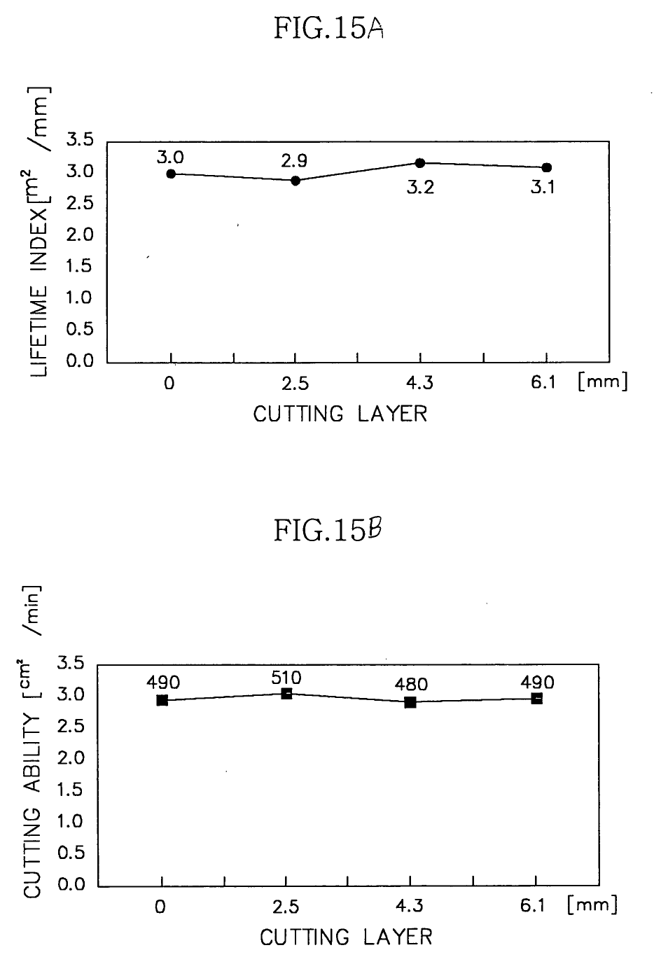

FIG. 15A is a graph illustrating the lifetime index of a cutting tip of the invention, in which a vertical axis indicates wearing variation in the height of the cutting tip (cutting layer) and a longitudinal axis indicates lifetime indices of the cutting tip.

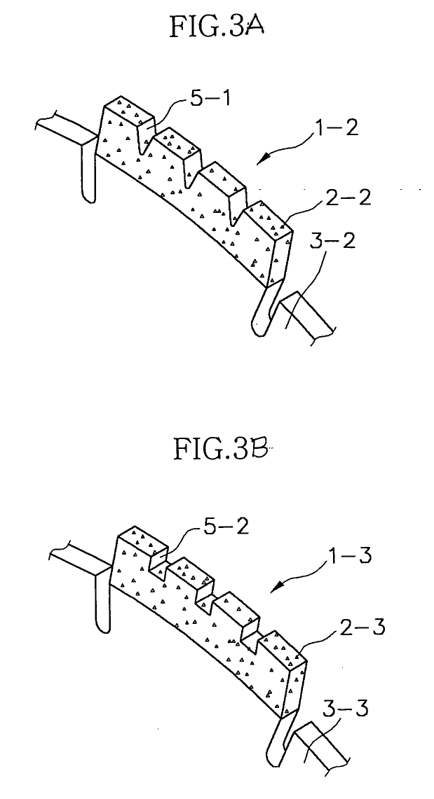

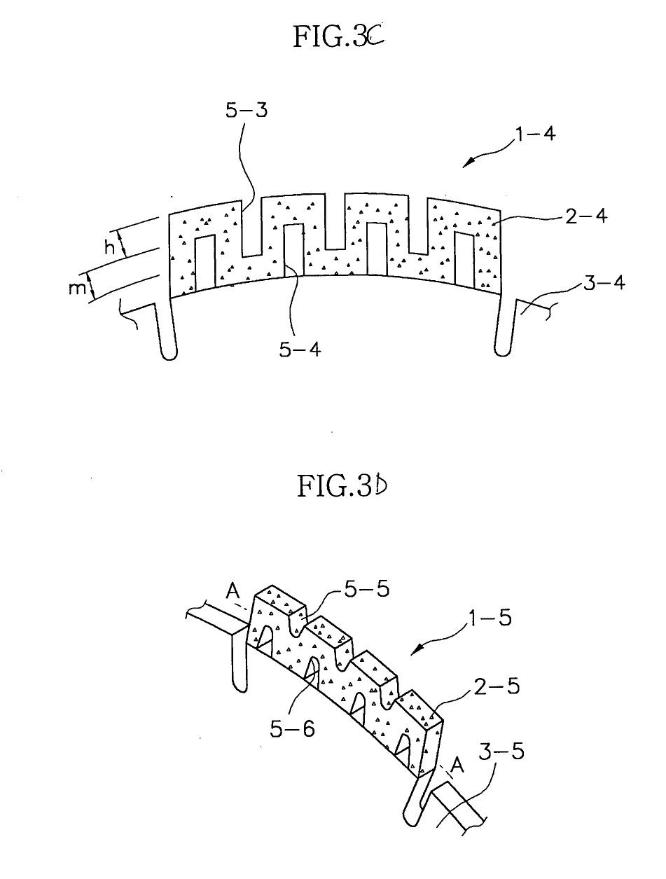

As shown in FIG. 15A, the amount of worked work piece is substantially uniform regardless of the height of the cutting tip. For example, the ratio of worked work piece per unit length of the cutting tip is 3.0 at the initial stage shown in FIG. 14A, 2.9 at the initial stage shown in FIG. 14B and 3.2 or 3.1 at the last stage shown in FIG. 14C. Therefore, the cutting tip of the invention can cut a work piece at a uniform wearing rate until the cutting tip is worn and thus the entire lifetime thereof is prolonged.

FIG. 15B is a graph illustrating the workability of a cutting tip of the invention, in which a vertical axis indicates wearing variation in the height of the cutting tip (cutting layer) and a longitudinal axis indicates lifetime indices of the cutting tip.

As shown in FIG. 15B, the working rate of the cutting tip is substantially uniform regardless of the height of the cutting tip. For example, the ratio of worked work piece per minute is 490 at the initial stage shown in FIG. 14A, 510 at the initial stage shown in FIG. 14B and 480 or 490 at the last stage shown in FIG. 14C. Therefore, the cutting tip of the invention can cut a work piece at a uniform cutting ability until the cutting tip is worn and thus the entire cutting ability is raised.

Although the four grooves are formed on the working plane of the segmental cutting tip in the embodiments of the invention, two to five grooves are preferably formed on the working plane. If too may grooves are formed in a predetermined length, for example, six or more grooves are formed, the absolute length of the cutting tip is reduced too much so that lateral load to the cutting tip is increased during the working use thereby increasing risk of separating the cutting tip from the shank. Further, impact load applied to divided tips in the segmental cutting tip is intensified too much so that the super abrasive particles are under intensified impact load. As a result, the super abrasive particles may be readily broken the bond layer or separated from the bond layer.

In particular, the cutting tips shown in FIG. 8 preferably has a width range of about 0.1 to 0.5 mm and its bond layer is thicker than the blank layer so as to prevent the blank layer from directly contacting a work piece and thus reduce frictional load, thereby realizing relatively excellent cutting ability.

The following description will present a fabrication process of the serrated cutting tip of the invention and the serrated cutting tool having the cutting tip attached thereto.

First, a mold is previously prepared to form a bond layer by uniformly mixing super abrasive powder such as Diamond and Cubic Boron Nitride (CBN) and bond and a blank layer made of metal powder only. Outer peripheral grooves of the bond layer are meshed with projections of the blank layer corresponding to the outer peripheral grooves, and meshed bond and blank layers are sintered in a sintering mold to fabricate a cutting tip.

In the meantime, the cutting tip can be fabricated by using a specially prepared mold so that a bond layer and a blank layer are formed into a unitary body and then sintered in the mold.

The cutting tip fabricated as above is attached to the outer periphery of a corresponding shank via silver soldering, laser or diffusion sintering to fabricate the cutting tool.

Further, the segmental or continuous rim cutting tip of the invention can be modified into a turbo-segmental or turbo-continuous rim cutting tip by forming grooves in both lateral faces with respect to its working plane.

In the cutting tips according to the embodiments of the invention, although the grooves in the bond layers and the projections in the blank layers are V- or U-shaped or in the form of a quadrangular column, the sectional shape of each groove can be variously formed into a polygonal column such as a triangular column or a stepped column.

Further, the cutting tip and the cutting-tool of the invention can be fabricated to have various characteristics by varying fabrication conditions such as sintering, silver soldering and laser welding.

### INDUSTRIAL APPLICABILITY

According to the serrated cutting tip and the serrated cutting tool having the cutting tip attached thereto of the present invention as set forth above, the bond layer includes the working plane functioning as a chip pocket which can uniformly maintain the working area to receive and outwardly discharge debris from the work piece and the grooves formed on a face of the bond layer attached to the shank, and the blank layer tightly contacts with the grooves in the face of the bond layer attached to the shank, by which cutting rate can be uniformly maintained.

Further, debris from the work piece are discharged to the outside substantially along with the working use instead of remaining at the cutting tip so that the work piece is directly rubbed with the super abrasive particles. As a result, the cutting ability is enhanced and thus the work piece can be worked more precisely.

Further, the outer peripheral grooves reduce the frictional area of the bond layer to apply a suitable amount of cutting load to the super abrasive particles so that the work piece produces large debris and the super abrasive particles are sharply broken so as to improve cutting ability. Since the conventional turbo-segmental cutting tip has relatively smaller number of super abrasive particles buried in its lateral portions, abrasion is carried out along a curved face to make the tip in the form of a blade thereby accelerating abrasion. This can also cause severe shaking of the shank during working use. However, the lateral portions of the cutting tip of the invention are uniformly abraded to prolong the lifetime.

The bond layer is strongly coupled with the shank via laser welding using the blank layer as a medium because the blank layer can be strongly bonded to the shank. Then, the shank can be fabricated into a tool for use in a dry use requiring thermal endurance and a hand-held use requiring a stronger bonding strength.

Further, the blank layer formed between the outer periphery of the shank and the bond layer of the cutting tip is meshed with the bond layer to increase the bonding area with the bond layer. Then, the blank and bond layers can endure external working impact as well as lateral load, thereby prevent separation of the cutting tool from the shank.

1. A cutting tip attached to an outer periphery of a shank, which has a predetermined rotation radius and a first thickness, and adapted to work a work piece, the cutting tip comprising:
a bond layer having a first width in a direction of the first thickness, a first height in a direction same as that of the shank and a radius of curvature same as that of the shank, the bond layer including grooves which are alternatingly formed on a first plane of the bond layer which is in contact with the work piece and a second plane of the bond layer adjacent to the outer periphery of the shank; and
a blank layer having a second width in a direction of the first thickness, a second height in a direction same as that of the shank and a radius of curvature same as that of the shank, the blank layer being tightly coupled with the bonding layer in a corresponding manner with the grooves formed on the second plane of the bond layer adjacent to the outer periphery of the shank to attach the bond layer to the outer periphery of the shank,
wherein the bond layer contains super abrasive particles and metal powder, and the blank layer contains metal powder.

2. The cutting tip as set forth in claim 1, wherein the radii of curvature of the bond and blank layers have a degree of bending with respect to a height direction of the bond and blank layers.

3. The cutting tip as set forth in claim 1, wherein the grooves have a rounded cross section in a height direction of the bonding layer from the first and second planes.

4. The cutting tip as set forth in claim 1, wherein the grooves have a quadrangular cross section in a height direction of the bonding layer from the first and second planes.

5. The cutting tip as set forth in claim 1, wherein the grooves formed on the first plane which is in contact with the work piece have a cross section which is angled by the side of the first plane and rounded adjacent to the outer periphery of the shank, and wherein the grooves formed on the second plane adjacent to the outer periphery of the shank have a cross section which is rounded adjacent to the outer periphery of the shank and angled adjacent to the first plane.

6. The cutting tip as set forth in claim 1, wherein the first width is larger than the second width.

7. The cutting tip as set forth in claim 6, wherein the grooves have a quadrangular cross section in a height direction of the bond layer from the planes.

8. The cutting tip as set forth in claim 2, wherein the bond layer and the blank layer are extended by a predetermined length in a peripheral direction of the outer periphery.

9. The cutting tip as set forth in claim 8, wherein the grooves have a rounded cross section in a height direction of the bond layer from the planes.

10. The cutting tip as set forth in claim 8, wherein the grooves have a quadrangular cross section in a height direction of the bond layer from the planes.

11. The cutting tip as set forth in claim 8, wherein the grooves formed on the first plane which is in contact with the work piece have a cross section which is angled by the side of the first plane and rounded adjacent to the outer periphery of the shank, and wherein the grooves formed on the second plane adjacent to the outer periphery of the shank have a cross section which is rounded adjacent to the outer periphery of the shank and angled adjacent to the first plane.

12. The cutting tip as set forth in claim 8, wherein the first width is larger than the second width.

13. The cutting tip as set forth in claim 12, wherein the grooves have a quadrangular cross section in a height direction of the bond layer from the planes.

14. The cutting tip as set forth in claim 1, wherein the radii of curvature of the bond and blank layers have a degree of lateral bending with respect to a height direction of the bond and blank layers.

15. The cutting tip as set forth in claim 14, wherein the grooves have a rounded cross section in a height direction of the bond layer from the planes.

16. The cutting tip as set forth in claim 14, wherein the grooves have a quadrangular cross section in a height direction of the bond layer from the planes.

17. The cutting tip as set forth in claim 14, wherein the grooves formed on the first plane which contacts the work piece have a cross section which is angled by the side of the first plane and rounded adjacent to the outer periphery of the shank, and wherein the grooves formed on the second plane adjacent to the outer periphery of the shank have a cross section which is rounded adjacent to the outer periphery of the shank and angled adjacent to the first plane.

18. The cutting tip as set forth in claim 14, wherein the first width is larger than the second width.

19. The cutting tip as set forth in claim 18, wherein the grooves have a quadrangular cross section in a height direction of the bond layer from the planes.

20. The cutting tip as set forth in claim 14, wherein the bond and blank layers are extended by a predetermined length in a peripheral direction of the outer periphery.

21. The cutting tip as set forth in claim 20, wherein the grooves have a rounded cross section in a height direction of the bond layer from the planes.

22. The cutting tip as set forth in claim 20, wherein the grooves have a quadrangular cross section in a height direction of the bond layer from the planes.

23. The cutting tip as set forth in claim 20, wherein the grooves formed on the first plane which is in contact with the work piece have a cross section which is angled by the side of the first plane and rounded adjacent to the outer periphery of the shank, and wherein the grooves formed on the second plane adjacent to the outer periphery of the shank have a cross section which is rounded adjacent to the outer periphery of the shank and angled adjacent to the first plane.

24. The cutting tip as set forth in claim 20, wherein the first width is larger than the second width.

25. The cutting tip as set forth in claim 20, wherein the grooves have a quadrangular cross section in a height direction of the bond layer from the planes.

26. The cutting tip as set forth in claim 1, wherein the blank layer further contains super abrasive particles to a ratio with respect to metal powder same as or less than the ratio of the super abrasive particles with respect to metal powder in the bond layer.

27. A serrated cutting tool comprising:
a shank having a predetermined rotation radius and a first thickness; and
a cutting tip attached to an outer periphery of the shank for working a work piece,
wherein the cutting tip comprises: a bond layer having a first width in a direction of the first thickness, a first height in a direction same as that of the shank and a radius of curvature same as that of the shank, wherein the bond layer includes grooves which are alternatingly formed on a first plane of the bond layer which is in contact with the work piece and a second plane of the bond layer adjacent to the outer periphery of the shank; and
a blank layer having a second width in a direction of the first thickness, a second height in a direction same as that of the shank and a radius of curvature same as that of the shank, the blank layer being tightly coupled with the bonding layer in a corresponding manner with the grooves formed on the second plane of the bond layer adjacent to the outer periphery of the shank to attach the bond layer to the outer periphery of the shank, and
wherein the bond layer contains super abrasive particles and metal powder, and the blank layer contains metal powder.

28. The serrated cutting tool as set forth in claim 27, wherein the radii of curvature of the bond and blank layers have a degree of bending with respect to a height direction of the bond and blank layers.

29. The serrated cutting tool as set forth in claim 27, wherein the bond and blank layers are extended by a predetermined length in a peripheral direction of the outer periphery.

30. The serrated cutting tool as set forth in claim 27, wherein the radii of curvature of the bond and blank layers have a degree of bending with respect to a height direction of the bond and blank layers.

31. The serrated cutting tool as set forth in claim 27, wherein the blank layer further contains super abrasive particles to a ratio with respect to metal powder same as or less than the ratio of the super abrasive particles with respect to metal powder in the bond layer.
